(19) United States
(12) Patent Application Publication
(10) Pub. No.: US 2009/0269431 A1
(43) Pub. Date: Oct. 29, 2009

(54) Compression molding an annular closure shell

(75) Inventors: Daniel L. Mattice, Columbia City, IN (US); Vance E. Reed, Columbia City, IN (US)

Correspondence Address: REISING ETHINGTON P.C., P O BOX 4390, TROY, MI, 48099-4390, US

(73) Assignee: Rexam Closure Systems Inc.

(21) Appl. No.: 12/150,549

(22) Filed: Apr. 29, 2008

(51) Int. Cl. B28B 3/00; B28B 5/10; B28B 7/10

(52) U.S. Cl. 425/350; 425/422

(57) ABSTRACT

Apparatus for compression molding an annular closure shell having a base wall with a center opening and, in accordance with one aspect of the disclosure, includes male and female mold sections having associated male and female mold surfaces that generally oppose each other. The female mold section includes an opening in the female mold surface and a mold pin extending through the opening. The male and female mold surfaces cooperate to generally define the base wall of the annular closure shell and the mold pin cooperates with the male mold section to generally define the center opening of the annular closure shell. Closure of the male and female mold sections forms an annular mold cavity for receiving and compression molding a mold charge into the annular closure shell having the base wall with the center opening, which at least partially surrounds the mold pin.

The present disclosure is directed to compression molding closure shells having openings in base walls of the shells.

### BACKGROUND AND SUMMARY OF THE DISCLOSURE

Machines for compression molding closure shells typically include a turret or carousel that rotates around a vertical axis. A plurality of molds around the periphery of the carousel include male and female mold sections that are aligned along vertical axes parallel to the axis of rotation. Cams drive one or both of the mold sections of each pair between an open spaced-apart position, in which a molded part is stripped from the male mold section and a charge of plastic material is placed in the female mold section, and a closed position in which the male and female mold sections are brought together to compression mold the charge to form the shell. U.S. patents that illustrate machines of this type for compression molding plastic closure shells include 5,670,100, 5,989,007, 6,074,583 and 6,478,568.

There are applications in which it is desirable to provide an opening in the base wall of the closure shell. For example, U.S. 2004/0108294A1 discloses a plastic closure that includes a shell having a base wall with a central opening and a skirt with at least one internal thread or bead for securing the closure to a container finish. A plastic disk is retained within the shell parallel to but spaced from the closure base wall. One or more axially extending spacer elements on the disk engage the undersurface of the closure base wall and space the disk from the base wall of the shell. A resilient liner is disposed on the underside of the disk for sealing engagement with the container finish. Following application of the closure to a container finish, fluid may be directed through the opening in the closure base wall, between the disk and the undersurface of the base wall, past the spacer elements, and then between the closure skirt and the container finish to flush debris or the like from between the closure shell and the disk and finish. Another example would be a closure shell having an opening to receive a dispensing valve or the like. In compression molding closure shells of this type, the shell may be fabricated with a disk in the base wall, which is removed in a post-molding operation to provide the desired opening in the base wall of the shell. U.S. Pat. Nos. 5,927,567 and 6,673,295 disclose closure shells and methods of manufacture of this type.

More recently, a method and machine were developed to compression mold a closure shell to have a base wall and a sacrificial disk connected to the base wall by a frangible web, wherein the sacrificial disk and the shell are stripped separately so that the shell emerges from the machine with an opening formed in the base wall by removal of the disk, thereby eliminating the need for a post-molding operation to remove the disk from the shell. U.S. Patent Publication 2007/0098836 disclose a method and machine of this type.

A general object of the present disclosure, in accordance with one aspect of the disclosure, is to provide an apparatus for compression molding an annular closure shell having a base wall with an opening, eliminating the need for either a post-molding operation or a stripping operation to remove the disk from the shell and also eliminating waste associated with the sacrificial disk.

The present disclosure embodies a number of aspects that can be implemented separately from or in combination with each other.

Apparatus in accordance with one aspect of the disclosure, for compression molding an annular closure shell having a base wall with a center opening, includes male and female mold sections having associated male and female mold surfaces that generally oppose each other. The female mold section includes an opening in the female mold surface and a mold pin extending through the opening. The male and female mold surfaces cooperate to generally define the base wall of the annular closure shell and the mold pin cooperates with the male mold section to generally define the center opening of the annular closure shell. Closure of the male and female mold sections forms an annular mold cavity for receiving and compression molding a mold charge into the annular closure shell having the base wall with the center opening, which at least partially surrounds the mold pin.

In accordance with another aspect of the disclosure, there is provided a machine for compression molding plastic annular closure shells, which includes a support for rotation around a horizontal axis and a plurality of compression molds on the support at angularly spaced positions around the axis. Each of the molds includes a male mold section and a female mold section aligned along an axis perpendicular to the horizontal axis. A cam is disposed adjacent to the support to move at least one of the mold sections of each mold with respect to the other mold section between a closed position forming a compression mold cavity and an open position spaced from each other. The male and female mold sections have associated male and female mold surfaces that generally oppose each other. The female mold section includes a cavity insert at least partially defining the female mold surfaces and having an opening, a mold pin extending through the opening and including an interior and a cooling fluid passage in communication with the interior, and a spring that biases the mold pin toward the male mold section. The male and female mold surfaces cooperate to generally define the base wall of the annular closure shell and the mold pin cooperates with the male mold section to generally define the center opening of the annular closure shell. Closure of the male and female mold sections forms an annular mold cavity for receiving and compression molding a mold charge into the annular closure shell having the base wall with the center opening, which at least partially surrounds the mold pin. The male mold section includes a mold core and a stripper sleeve surrounding the mold core for movement both rotationally and axially of the mold core. The male mold section also includes a first screw drive coupling the female mold section to the stripper sleeve for rotating the stripper sleeve around the mold core as the at least one mold section is moved between the open and closed positions. The male mold section further includes a second screw drive coupling the stripper sleeve to the support to move the stripper sleeve axially over the mold core as the stripper sleeve is rotated around the core, so that the stripper sleeve rotationally and axially removes the annular closure shell molded around the male mold core as the at least one mold section is moved with respect to the other mold section toward the open position.

### BRIEF DESCRIPTION OF THE DRAWINGS

The disclosure, together with additional objects, features, advantages and aspects thereof, will be best understood from the following description, the appended claims and the accompanying drawings, in which:

FIG. 1 is a front elevational view of a compression molding machine in accordance with one embodiment of the present disclosure;

FIG. 2 is a side elevational view of the compression molding machine illustrated in FIG. 1;

FIGS. 3A-3C together form a sectional view taken substantially along the line 3-3 in FIG. 2; and

FIG. 4 is an enlarged fragmentary sectional view taken from circle 4 of FIG. 3A.

### DETAILED DESCRIPTION OF PREFERRED EMBODIMENTS

The disclosure of above-noted U.S. 2004/0108294A1 is incorporated herein by reference.

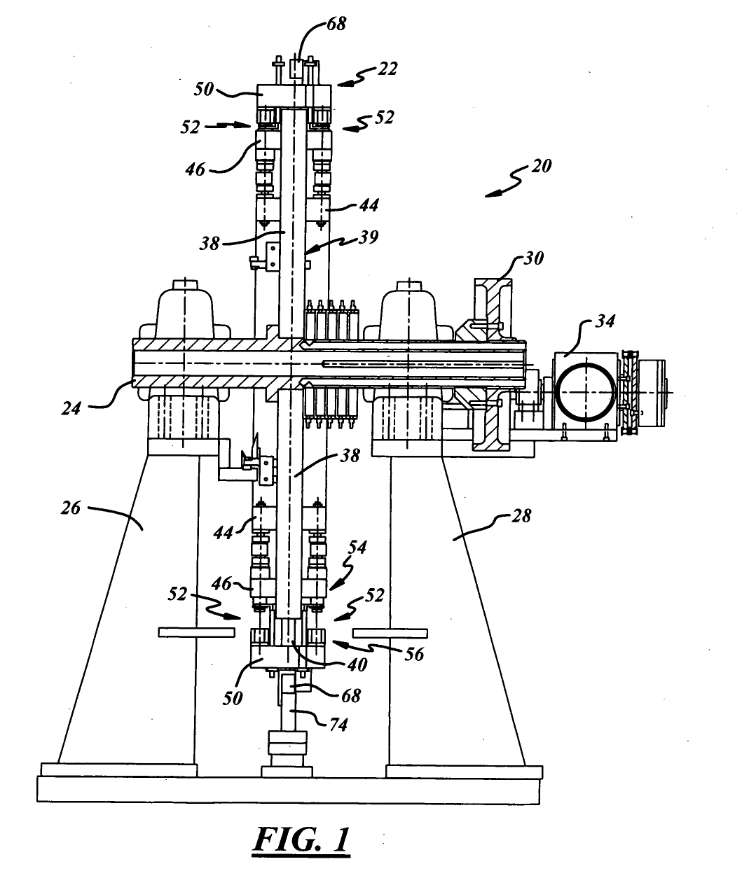

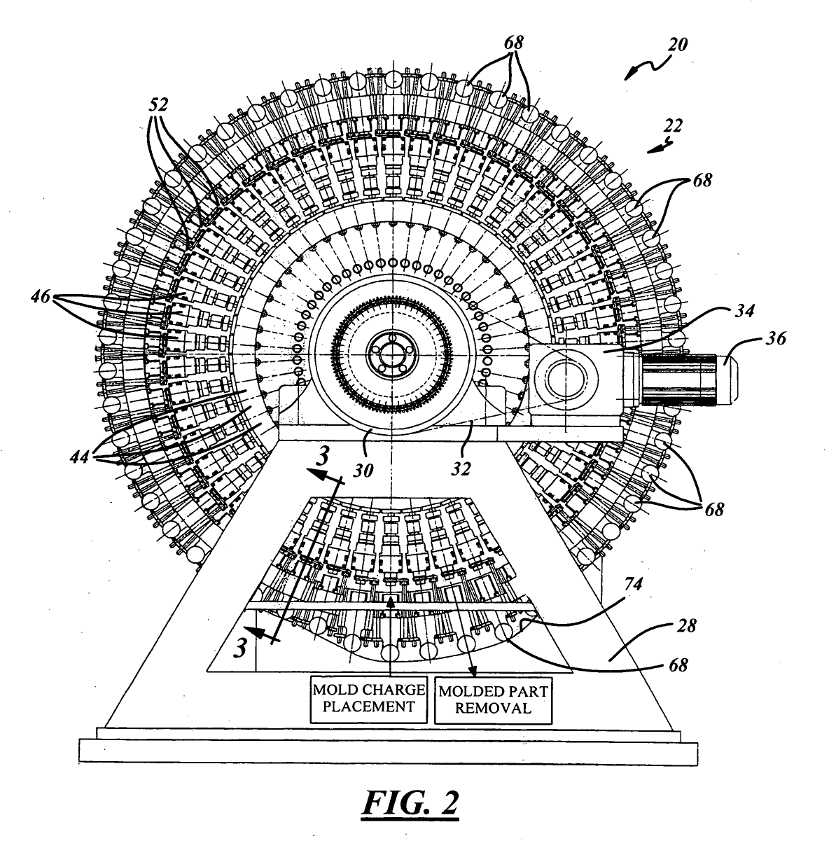

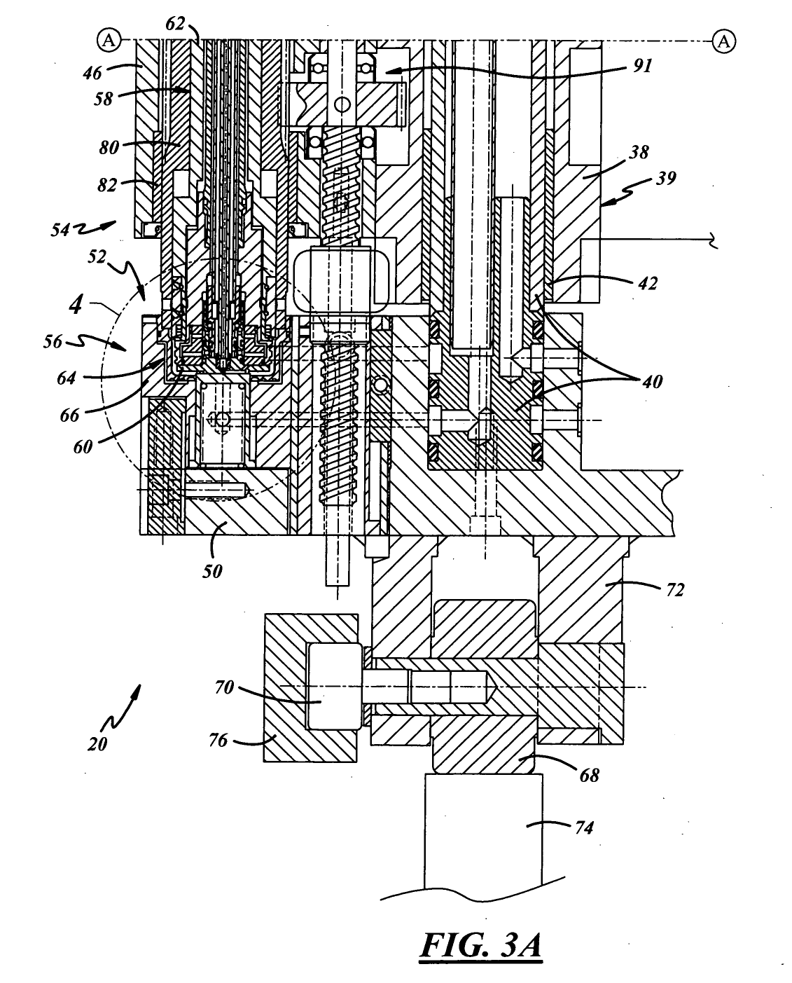

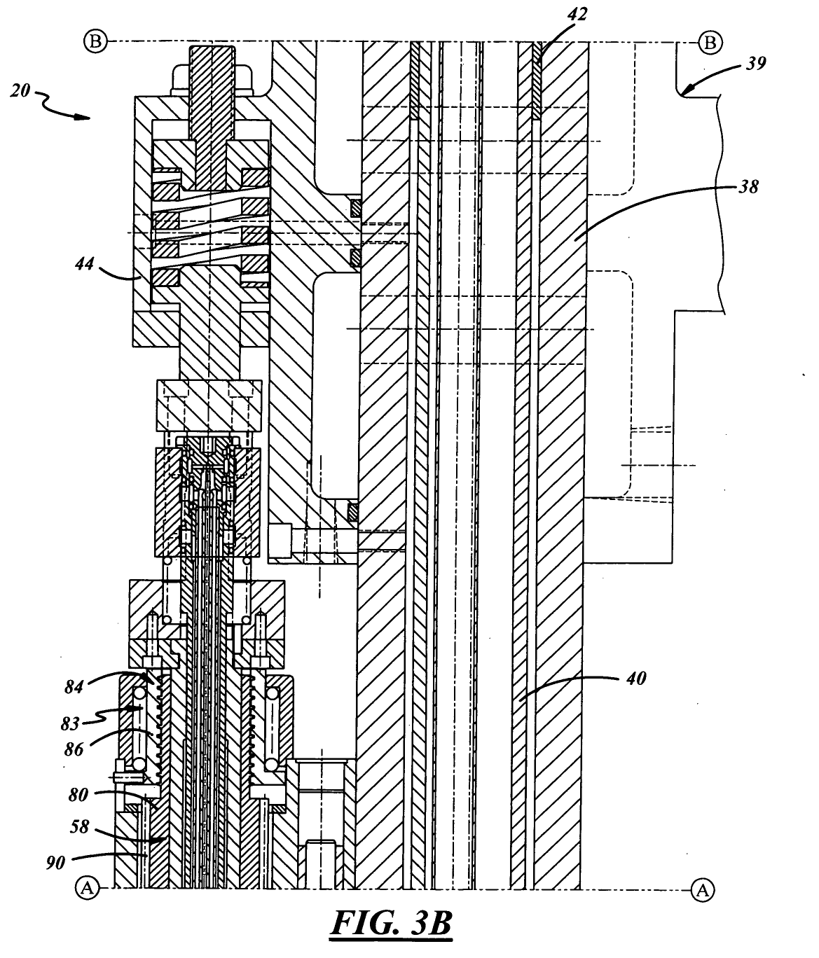

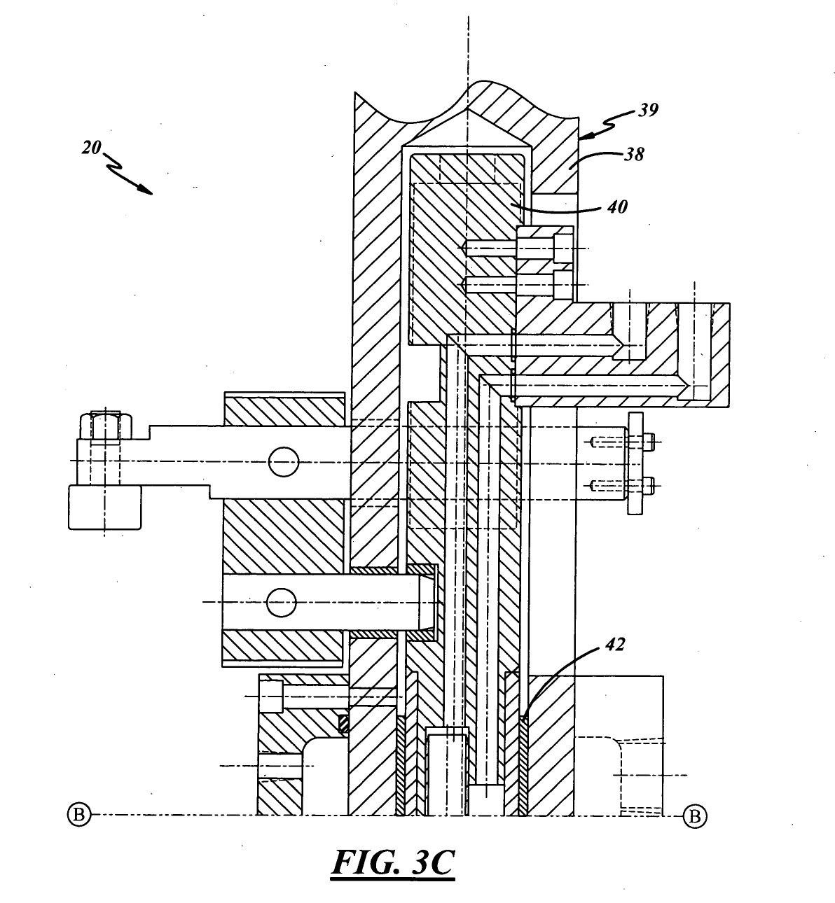

FIGS. 1-2 illustrate a machine 20 for compression molding plastic closure shells in accordance with one embodiment of the present disclosure. Machine 20 includes a wheel 22 mounted on a shaft 24 between spaced supports 26, 28. Shaft 24 is coupled by a pulley 30, a belt 32 (FIG. 2) and a gearbox 34 to a motor 36 for rotating shaft 24 and wheel 22 around a horizontal axis. Wheel 22 includes a hub (which may be part of shaft 24) and a support 39 extending radially from the hub. Support 39 may comprise a solid disk or the like, or more preferably a plurality of angularly spaced radially extending support spokes 38. Each support spoke 38 preferably is hollow at its outer end, as best seen in FIGS. 3A-3D. A rod 40 is slidably supported, such as by sleeve bearings 42, within the hollow outer end of each spoke 38. A crossbar 50 is coupled to the outer end of each rod 40, so that the combination of rod 40 and bar 50 preferably is generally T-shaped as viewed from the tangential direction in FIG. 3A. A plurality of radially spaced external supports 44, 46 are provided on spokes 38, preferably on each axial side of each spoke. The radially inner supports 44 on the series of spokes preferably form circumferentially continuous support rings, as best seen in FIG. 2. Radially outer supports 46 preferably are circumferentially spaced from each other. A plurality of angularly spaced molds 52 are disposed around the periphery of wheel 22, preferably but not necessarily on both sides of the wheel. Each mold 52 is disposed between supports 44, 46 on the associated spoke 38 and an end of crossbar 50 on rod 40. All molds 52 preferably are identical. To the extent thus far described, machine 20 is similar to that disclosed in U.S. Pat. No. 7,331,777 entitled “Compression Molding Machine,” the disclosure of which is incorporated herein by reference.

Each mold 52 preferably includes a radially inner first mold segment or section 54 and a second mold segment or section 56 in radial outward alignment with the associated first mold section 54. (Unless otherwise indicated, directional words such as “radial,” “tangential,” “inner” and “outer” are employed by way of description and not limitation with respect to the axis of rotation of wheel 22.) In the preferred embodiments of the disclosure, to the extent embodied in a vertical wheel machine, the radially inner first mold section 54 is a male mold section and the radially outer second mold section 56 is a female mold section, although these mold sections could be reversed in accordance with the broadest principles of the disclosure.

Male mold section 54 includes a mold core 58 having a core tip 60 contoured to form the desired inside geometry of the annular closure shell and carried at an end of a core sleeve 62. The core sleeve 62 may be a single component or an assembly of multiple components. In any case, the core tip 60 and sleeve 62 at least partially define male mold surfaces.

Female mold section 56 includes a cavity insert 64 mounted by a support block 66 on crossbar 50. Insert 64 has a geometry to at least partially form the desired outer contour of the annular closure shell. In other words, the insert 64 at least partially defines female mold surfaces that generally oppose the male mold surfaces.

Cam rollers 68, 70 are mounted on supports 72 that extend from crossbar 50 for engagement with cams 74, 76 to move female mold sections 56 radially inwardly and outwardly with respect to male mold sections 54 as a function of rotation of wheel 22 around its axis.

Male mold section 54 also includes a stripper sleeve 80 that surrounds mold core 60. Stripper sleeve 80 is movable both axially with respect to mold core 60 (i.e., in the direction of the axis of the mold core) and circumferentially or rotationally around the outer surface of the mold core. Stripper sleeve 80 is carried within support 46 by a sleeve bearing 82 near the radially inner end of sleeve 80 (with respect to the axis of wheel rotation). External threads near the inner end 84 of the stripper sleeve engage an internally threaded collar 86 carried by support 46 to form a screw drive 83. Also, a screw drive 91 couples female mold section 56 to stripper sleeve 80. The screw drives 83, 91 and stripper sleeve 80 are substantially similar to that disclosed in U.S. Pat. No. 7,241,129, which is incorporated herein by reference in its entirety.

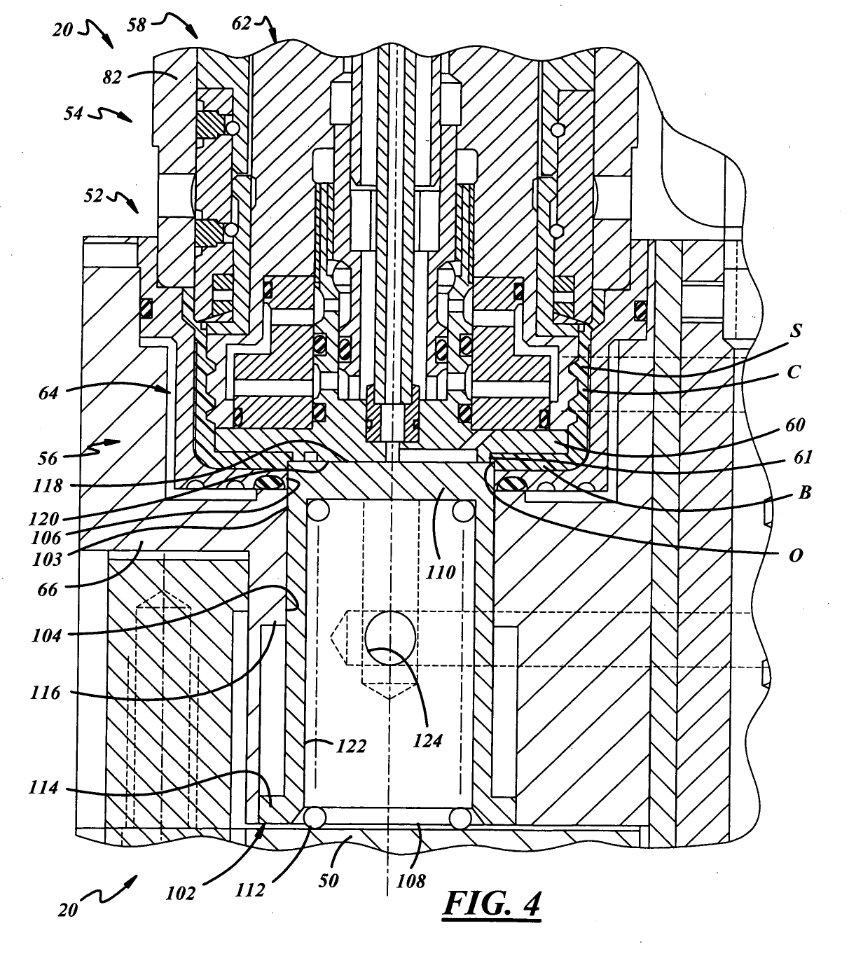

Referring to FIG. 4, closure of the male and female mold sections 54, 56 forms an annular mold cavity for receiving and compression molding a mold charge into an annular closure shell C having a base wall B with a center opening O. The male and female mold sections 54, 56 have associated male and female mold surfaces that generally oppose each other to generally define the base wall B and a skirt S of the annular closure shell C. Also, the female mold section 56 includes a mold pin 102 carried in an opening 104 of the support block 66 and extending through an opening 106 in the insert 64. The mold pin 102 cooperates with the male mold section 54 to generally define a center opening O in the base wall B of the annular closure shell C.

The mold pin 102 may be cup-shaped with an open end 108 and a generally opposite closed end 110, and may be biased toward the male mold section 54 by a spring 112 that may be positioned at least partially within the mold pin 102 between the closed end 110 and the crossbar 50. To limit travel of the mold pin 102 into the mold cavity relative to the support block 66, the mold pin 102 may include a shoulder 114 that may be generally disposed at the open end 108 for cooperation with a corresponding shoulder 116 of the support block 66. An inward surface 118 of the mold pin 102 engages a corresponding outward surface 120 of the core tip 60.

The mold pin 102 may include an interior 122 in which the spring 112 is at least partially disposed and in which cooling fluid may be received such as via one or more cooling fluid passages 124. The cooling fluid passage(s) 124 may extend generally transversely through a side wall of the mold pin 102 to be in fluid communication with the interior 122. Also, the cooling fluid passage(s) 124 may be supplied with cooling fluid in any suitable manner, such as via fluid communication with any suitable cooling fluid circuits of the machine 20.

One or the other of an outer diameter or surface 103 of the mold pin 102 and/or an outer diameter or surface 61 of the core tip 60 may define the central opening O through the base wall B of the closure C. Accordingly, the opening O at least partially surrounds the mold pin 102.

When the male mold section 54 retracts relative to the female mold section 56 for placement of a mold charge into the female mold section 56, the mold pin 102 may extend a substantial distance into the cavity insert 64 of the female mold section 56 toward the male mold section 54. The mold charge is placed in the cavity insert 64 around the mold pin 102. For example, a single mold charge pellet may be placed in the cavity insert 64, a pair mold charge pellets may be placed on diametrically opposed sides of the mold pin 102 within the insert 64, multiple mold charge pellets may be distributed around the mold pin 102 within the insert 64, or an annular mold charge may be placed over the mold pin 102.

As the male mold section 54 closes relative to the female mold section 56, the inward surface 118 of the mold pin 102 engages a corresponding portion of the male mold section 54, such as the outward surface 102 of the core tip 60, so as to close a center portion of the mold cavity against the flow of plastic material. The mold pin 102 becomes displaced from its extended position in the cavity insert 64 to its molding position as shown in FIG. 4 while maintaining contact with the male mold section 54. Thus, the base wall B of the annular closure shell C—as molded—is in the form of an annulus that has the center opening O surrounding the mold pin 102.

Therefore, no sacrificial disk of the annular closure shell C need be formed or need be removed by a separate stripping operation and equipment. Moreover, the center opening O of the annular closure shell C may be relatively finish formed, instead of fractured as a result of a sacrificial disk frangibly connected to a base wall being sheared away from the base wall.

As used herein, directional words such as top, bottom, upper, lower, radial, circumferential, lateral, longitudinal, vertical, horizontal, inward, outer, and the like are employed by way of description and not limitation.

There thus has been disclosed a machine for compression molding annular plastic closures, that fully satisfies all of the objects and aims previously set forth. The disclosure has been presented in conjunction with several exemplary embodiments, and additional modifications and variations have been discussed. Other modifications and variations readily will suggest themselves to persons of ordinary skill in the art in view of the foregoing discussion. For example, although mounting of the molds on a vertical wheel rotatable around a horizontal axis is presently disclosed, the exemplary embodiments could as readily be implemented in a horizontal wheel or carousel-type machine that rotates around a vertical axis, and in which the molds are aligned along axes parallel to the axis of rotation. The disclosure is intended to embrace all such modifications and variations as fall within the spirit and broad scope of the appended claims.

1. Apparatus for compression molding an annular closure shell having a base wall with a center opening, which includes:
a male mold section and a female mold section, said male and female mold sections having associated male and female mold surfaces that generally oppose each other,
said female mold section including an opening in said female mold surface and a mold pin extending through said opening, wherein said male and female mold surfaces cooperate to generally define the base wall of the annular closure shell and wherein said mold pin cooperates with said male mold section to generally define the center opening of the annular closure shell,
such that closure of said male and female mold sections forms an annular mold cavity for receiving and compression molding a mold charge into the annular closure shell having the base wall with the center opening, which at least partially surrounds said mold pin.

2. The apparatus set forth in claim 1 wherein said female mold section further includes a spring that biases said mold pin toward said male mold section.

3. The apparatus set forth in claim 1 wherein at least one of said male and female mold sections is movable with respect to the other between an open position spaced from each other for removing the molded annular closure shell and placing a mold charge into said mold, and a closed position for compression molding the annular closure shell.

4. The apparatus set forth in claim 1 wherein male mold section includes a mold core and a core tip carried by said mold core, and said mold pin is biased toward said male mold section and includes a surface to contact a corresponding surface of said core tip.

5. The apparatus set forth in claim 1 including a plurality of said male and female mold sections in radially opposed angularly spaced pairs around a wheel mounted for rotation around an axis.

6. The apparatus set forth in claim 5 wherein said axis is a horizontal axis and said female mold section is mounted radially outwardly of said male mold section in each said pair around said wheel.

7. The machine set forth in claim 5 including a cam disposed adjacent to said wheel for engaging said molds in sequence during rotation of said wheel to move at least one of said mold sections with respect to the other between said open and closed positions.

8. The apparatus set forth in claim 1 wherein said mold pin includes an interior and a cooling fluid passage in communication with the interior.

9. The apparatus set forth in claim 1 wherein said male mold section includes a mold core, a stripper sleeve surrounding said mold core, and means coupling said stripper sleeve to said female mold section to strip the annular closure shell from said mold core as one or both of said male and female mold sections move away from each other.

10. The apparatus set forth in claim 1 including means for feeding at least two mold charges to diametrically opposed sides of said annular mold cavity.

11. The apparatus set forth in claim 1 including means for feeding an annular mold charge into said annular mold cavity around said mold pin.

12. A machine for compression molding plastic annular closure shells, which includes:
a support for rotation around a horizontal axis,
a plurality of compression molds on said support at angularly spaced positions around said axis,
each of said molds including a male mold section and a female mold section aligned along an axis perpendicular to said horizontal axis,
a cam disposed adjacent to said support to move at least one of said mold sections of each mold with respect to the other mold section between a closed position forming a compression mold cavity and an open position spaced from each other,
said male and female mold sections having associated male and female mold surfaces that generally oppose each other,
said female mold section including
a cavity insert at least partially defining said female mold surfaces and having an opening,
a mold pin extending through said opening and including an interior and a cooling fluid passage in communication with the interior, and
a spring at least partially disposed in said interior of said mold pin to bias said mold pin toward said male mold section,
wherein said male and female mold surfaces cooperate to generally define the base wall of the annular closure shell and wherein said mold pin cooperates with said male mold section to generally define the center opening of the annular closure shell,
such that closure of said male and female mold sections forms an annular mold cavity for receiving and compression molding a mold charge into the annular closure shell having the base wall with the center opening, which at least partially surrounds said mold pin,
said male mold section including a mold core and a stripper sleeve surrounding said mold core for movement both rotationally and axially of said mold core, a first screw drive coupling said female mold section to said stripper sleeve for rotating said stripper sleeve around said mold core as said at least one mold section is moved between said open and closed positions, and a second screw drive coupling said stripper sleeve to said support to move said stripper sleeve axially over said mold core as said stripper sleeve is rotated around said core, so that said stripper sleeve rotationally and axially removes the annular closure shell molded around said male mold core as said at least one mold section is moved with respect to the other mold section toward said open position.

13. The machine set forth in claim 12 wherein at least one of said male and female mold sections is movable with respect to the other between an open position spaced from each other for removing the molded annular closure shell and placing a mold charge into said mold, and a closed position for compression molding the annular closure shell.

14. The machine set forth in claim 12 wherein male mold section includes a mold core and a core tip carried by said mold core, and said mold pin is biased toward said male mold section and includes a surface to contact a corresponding surface of said core tip.

15. The machine set forth in claim 12 including a plurality of said male and female mold sections in radially opposed angularly spaced pairs around a wheel mounted for rotation around an axis.

16. The machine set forth in claim 15 wherein said axis is a horizontal axis and said female mold section is mounted radially outwardly of said male mold section in each said pair around said wheel.

17. The machine set forth in claim 1 wherein said mold pin includes an interior and a cooling fluid passage in communication with the interior.

18. The machine set forth in claim 12 wherein said male mold section includes a mold core, a stripper sleeve surrounding said mold core, and means coupling said stripper sleeve to said female mold section to strip the annular closure shell from said mold core as one or both of said male and female mold sections move away from each other.

19. The machine set forth in claim 12 including means for feeding at least two mold charges to diametrically opposed sides of said annular mold cavity.

20. The machine set forth in claim 12 including means for feeding an annular mold charge into said annular mold cavity around said mold pin.
